(19) United States
(12) Patent Application Publication
(10) Pub. No.: US 2019/0340623 A1
(43) Pub. Date: Nov. 7, 2019

(54) SYSTEM AND METHOD FOR VERIFYING AUTHENTICITY OF THE PRODUCTS BASED ON PROOF OF OWNERSHIP AND TRANSFER OF OWNERSHIP

(71) Applicant: SigmaLedger, Inc., Jersey City, NJ (US)

(72) Inventors: Oleksandr Rivkind, Jersey City, NJ (US); Roman Polupanov, Pfaffikon (CH)

(21) Appl. No.: 16/402,994

(22) Filed: May 3, 2019

Related U.S. Application Data
(60) Provisional application No. 62/666,368, filed on May 3, 2018.

(51) Int. Cl. G06Q 30/00; G06F 16/23

(52) U.S. Cl. CPC G06Q 30/0185; G06F 16/2365

(57) ABSTRACT

A system for determining and verifying authenticity of a product unit comprising: a ledger system comprising at least two nodes; at least one product code attached to said product unit, said product code having an entry in said at least two nodes, said entry defining at least a current owner and a hash of product information; said system capable of self-executing computer code for providing a request for transfer of ownership of said product unit by initiating a request from a portal, and accessing a first node of the at least two nodes; quantifying a consensus of the product information from the first node to a second node; engaging a self-executed computer code via confirming said ownership between said first and second nodes; and forwarding a request to an owner; upon approval by the owner confirming a change of ownership by registering and confirming a change within said first and second nodes.

### PRIORITY CLAIM

This application claims the benefit of U.S. provisional application No. 62/666,368 filed on May 3, 2018 with the US Patent and Trademark Office, the contents of which are incorporated herein by reference in their entirety.

### FIELD OF INVENTION

The present invention relates to Distributed Ledger systems for verifying authenticity of the products based on proof of ownership and transfer of ownership for preventing illicit trading, preventing counterfeiting and decreasing the risk of corruption.

### BACKGROUND OF THE INVENTION

Counterfeiting has become a global threat. According to OECD & EUIPO imports of counterfeit and pirated goods are worth nearly half a trillion dollars (461 billion USD) a year, or around 2.5% of global imports. Counterfeit products cause serious damage to economies, industries, consumer health and safety. Such criminality is widely spread across a number of sectors, e.g.: automotive parts, tobacco, luxury products, medicines, food and beverages, clothes, toys, etc. Remedies are often somewhat industry specific, though global solutions and strategies remain largely absent.

Legal resources, while available in many jurisdictions, however, do not prevent counterfeiting. Nor do they ensure recovery of a judgment that fully repairs the loss caused by the counterfeiting, since many of the perpetrators are hard to bring to justice and recover a judgment from. A number of initiatives, though, are ongoing to combat counterfeiting including implementing standards and certification, tightening customs control, improving IP enforcement, and raising criminal standards, among others. These initiatives are expensive and are inefficient, especially in countries with high levels of corruption.

Additional solutions, for example, those based upon registrations and a centralized database, remain woefully ineffective. Such systems are rapidly infiltrated by criminals, and this allows dishonest employees to amend records or to provide unauthorized access to untrustworthy 3rd parties. Also, the current serialization solutions cannot protect from copying of IDs/codes, which are easily fabricated by savvy criminals.

New solutions are necessary to generate confidence in goods which are prone to fraud. Herein are described certain embodiments and solutions that provide for increased security with regard to product registration, transfer of ownership and confirmation of validity of a genuine article.

### BRIEF DESCRIPTION OF THE INVENTION

In the broadest applications, the present embodiments are directed to a system and method utilizing Distributed Ledger systems for verifying authenticity of the products based on proof of ownership and transfer of ownership for preventing illicit trading, preventing counterfeiting and decreasing the risk of corruption, as described and disclosed herein.

In a further preferred embodiment, a system defined to reduce counterfeit goods comprising: a public or private or hybrid (combination of public and private) distributed ledger (e.g. blockchain distributed ledger); allowing any interested party as well as individuals to join the distributed ledger and act as an additional validator and controlling member; create components, services and APIs for such parties to minimize the effort to join the ledger; create workplaces for members of supply chain (supplier, manufacturer, distributor, retailer, etc.); create digital identity systems, which will be used for authentication and allow anonymous access for certain scenarios; create SLID generator, which creates global unique identifiers for product units and batches; create ownership tracking logic (for example, using workflow engines or state machine or smart contracts or others); there can be one of more smart contracts created and deployed to the distributed ledger, each smart contact will have a public address assigned; deploy the tracking logic to the distributed ledger; create API interface (for example, REST Web Services) for registering products, product units, querying information about products and product units, registering trades (transferring of ownership), proving ownership, changing the status of the product unit, and other operations; create retailer mobile application for product unit validations, transfer of ownership and changing product unit status when product unit is sold to a consumer; and create consumer mobile application for product unit authenticity validation, proof and transfer of ownership and submitting complaints, the consumer mobile application should allow but should not require registration. Validation of product unit can be done by scanning a QR code, DNA tag, or chemical spectral tag (or other physical form of SLID). Validation of product unit shall not require a proprietary consumer application and can be done using customary QR code scanner (or any other depending on the way of SLID representation).

A method of confirming and validating ownership of a product unit comprising: generating an SLID corresponding to a product unit and registering the product unit within a Distributed Ledger, and attaching the SLID to an individual product units; Ownership of the SLID can be validated at any trade, whereby the ownership must be transferred at any trade. SLID must be marked as “sold” when product unit is sold to a consumer. A consumer can demand proof of ownership and mark as sold utilizing procedures from the retailer. Failure to prove or transfer ownership as well as attempt to sell “sold” SLID, indicates counterfeit. Furthermore, via the processes described herein, the consumer exits as an owner of the good, and confirmation of that transfer of ownership is provided in real-time to effectuate said transfer within the Ledger.

In a further preferred embodiment, a system for determining and verifying authenticity of a product unit comprising: a ledger system comprising at least two nodes; at least one product code attached to said product unit, said product code having an entry in said at least two nodes, said entry defining at least a current owner and a hash of product information; said system capable of self-executing computer code for providing a request for transfer of ownership of said product unit by initiating a request from a portal or API, and accessing a first node of the at least two nodes; sending the request from the first node to a second node; engaging a self-executed computer code via confirming said ownership between said first and second nodes; and forwarding a request to an owner; upon approval by the owner confirming a change and engaging a self-executed computer code via confirming the validity of the change of ownership request and approval followed by consensus, making the change of ownership of said product unit within said first and second nodes.

In a further embodiment, the system wherein an API is utilized to access between the portal and the ledger system.

In a further embodiment, the system further comprising sending a receipt of said request from the portal to a buyer.

In a further embodiment, the system further comprising sending a change of ownership confirmation to a requester (the new owner) and previous owner.

In a further embodiment, the system wherein upon approval by the owner, a consensus is defined between said first and at least second node of the approval of the change of ownership, and upon consensus, making the change within said first and second nodes.

In a further embodiment, the system wherein the first and second nodes are operated by independent parties who participate in parallel, and wherein a change to any node is only propogated upon consensus between the first and second nodes. In a further embodiment, the system wherein consensus defines that no change is made to a node without the consent from all other parties.

In a further embodiment, the system wherein there are three or more nodes.

In a further embodiment, the system wherein each node has a complete copy of all transactions.

In a further embodiment, the system wherein data is partitioned among a plurality of nodes, wherein within each partition, each of the plurality of nodes has a complete copy of all transactions.

In a further embodiment, the system wherein the data points from the nodes are synced to a public ledger. In a further embodiment, the system wherein a hash of transactions from said nodes is synced with the public ledger.

In a further embodiment, a method of transferring ownership of a product unit within a ledger system comprising: generating an ID for a Product Unit; registering said ID within a node within said ledger system and attaching said ID to the Product Unit; propagating the ID within at least a second node within said ledger system; scanning the ID and submitting a request (transaction) to the Ledger; processing the request (transaction) and upon receipt of said request (transaction), executing a series of code to identify the current owner and registering the request in the ledger system; wherein the execution defines a change in at least one transaction data; and wherein said transaction data is validated and synced between the first node and at least second node in the Ledger; receiving a notification of the request by the current owner, and defining a transfer approval wherein said current owner approving the request to transfer to a requester; wherein the transfer approval (transaction) triggers execution of a self-executing code to match the transfer approval with the request, validate the approval and confirm the change in ownership by registering transaction data on the first and at least second nodes within the ledger; and generating a notification confirming the change in ownership.

In a further embodiment, the method wherein the process of the current owner approving the request to transfer ownership to a requester, wherein the approving is performed by the current owner singing the request; and wherein the validation is of the signature.

In a further embodiment, the method wherein the request is generated by a requester.

In a further embodiment, the method wherein registering said ID within a node defines an owner and information regarding said owner.

In a further embodiment, the method, wherein the step of submitting a request generates a PIN. In a further embodiment, the method wherein the PIN must be confirmed before change of ownership within the first and second node in the ledger.

In a further preferred embodiment, a method of proving ownership of a product unit comprising: generating an ID for a product unit and registering said ID within a ledger system among a plurality of nodes to define an owner of said product unit; and attaching said ID to the product unit; scanning the ID on said product unit and submitting a request to confirm the ownership on the Ledger; submitting said request wherein receipt triggers execution of self-executing code to identify the current owner; validating a data point, said data point defining at least the current owner among the plurality of nodes within the ledger and forming a consensus of said data point; generating a notification on the request to the owner; and approving the notification; validating the approved notification among the first and at least second nodes; and upon consensus among the first and at least second nodes confirming the ownership; and generating a notification of the ownership.

In a further embodiment, the method wherein the request to confirm ownership and the resulting confirmation are registered among the first and at least second node and may be used as a reference accessible via the API.

In a further embodiment, the method wherein registration of the product is defined within a node (i.e. a database), with a plurality of nodes possible.

In a further embodiment, the method wherein the proof of ownership request is submitted to one node, and wherein that first node propagates the request to other nodes, each of which validates and stores the data, followed by consensus to validate and accept (store) the data among the nodes.

In a further embodiment, the method wherein the proof of ownership approval notification is submitted to one node, and wherein that first node propagates the request to other nodes, each of which validates and stores the data, followed by consensus to validate and accept (store) the data among the nodes.

In a further embodiment, the method wherein each node has a complete copy of the data.

In a further embodiment, the method wherein data is partitioned among the plurality of nodes, wherein within each partition each node has a complete copy of the data.

In a further embodiment, the method wherein in step (c) the self-executing code is executed via submitting a request to a public address in the Ledger.

In a further preferred embodiment, a system defined to reduce counterfeit goods comprising: a distributed ledger system; a plurality of validating members having access to the distributed ledger and act as additional validator and controlling members; an API enabling communication to the ledger; at least one workplaces for members of a Supply Chain (Supplier, Manufacturer, Distributor, Retailer, etc.); a Digital Identity systems, which will be used for authentication and allow anonymous access for certain scenarios; an SLID generator, which creates global unique identifiers for Product Units, lots and batches; a set of computer readable self-executing code for tracking ownership; wherein ownership is validated and changed/transferred via a self-executable code executing upon receipt of instructions followed by consensus to validate and accept (store) the data among the nodes; wherein said code is capable of reading and/or writing to a node within the distributed ledger, each said ownership corresponding to a user ID; updating an SLID within a first node and copying said first node to other nodes; wherein validation of Product Unit can be done by scanning said SLID on said Product Unit; and validating the Product Unit within the nodes by confirming a consensus of the data among each node; and modifying data among each node pursuant to an approved request to modify said ownership data within each said node.

### BRIEF DESCRIPTION OF THE FIGURES

FIG. 1 is a schematic representation of an exemplary embodiment of the present invention.

FIG. 2 details an embodiment of ownership transfer and confirmation.

FIG. 3 details an embodiment of a further embodiment of ownership transfer and confirmation of the same comprising a PIN.

FIG. 4 details an embodiment of requesting proof of ownership between a consumer and an owner and provide proof of ownership.

FIG. 5 details an embodiment of a process for proving ownership of an item.

### DETAILED DESCRIPTION OF THE INVENTION

Criminals typically target goods to counterfeit which are easy to manufacture and/or have high margins. Of course, those goods that are both easy to manufacture and possess high margins are particularly at risk. Thus, solutions to limit the fraudulent production and sale of these goods is paramount to consumer confidence, and in many cases, also to consumer safety. Existing solutions to prevent counterfeiting remain ineffective despite their costs. The solutions herein provide for an elegant solution that dramatically increases the security surrounding goods and, in certain embodiments, places the consumer as a key driver of the product validity. This provides for mechanisms to increase consumer confidence that the goods they are purchasing are authentic goods intended for commerce and intended for sale to a given consumer.

The systems and methods described herein relate specifically to systems that generate increased confidence in the validity of a particular good by using Distributed Ledger Technology (DLT) based systems to verify the genuine nature of any given product that is placed within the various embodiments. Indeed, the systems and methods described herein offer several levels of protection for the consumer including but not limited to: ID validation; product information and pictures; seller name and location; proof/transfer of ownership.

DLT, and the methods herein that utilize DLT, store data, in their simplest forms, but allow for several different processes and steps to verify and authenticate a particular good. Database systems can increase safety, however storing the data in a regular database has two major flaws: (i) The database can be compromised by a dishonest employee, which can result either in leakage of valid identifiers or in altering of list of valid identifiers; and (ii) the valid unique identifier can be easily copied and attached to the fake product. The shortfalls of current DTL herein are resolved by the embodiments of the present disclosure.

This problem can be solved by the concept of a centralized database system, which requires a great level of control and transparency over supply chain and by providing a consumer with a trusted way to validate authenticity of the product. This approach assumes that for every produced item a unique identifier (SLID) is generated and attached to that item. Once generated, the SLID and the produced item are given an owner, and this information is stored within nodes on the system. All identifiers are stored in a database so at any moment in time, a given identifier can be checked against the database. However, to ensure that such entries are valid, and that the SLID within a given product is also valid, a further solution is required. The solution is to utilize DLT instead of a regular centrally controlled database. The solution can be based on any DLT implementation e.g. Ethereum, Quorum, Hyperledger, R3 Corda, or another private or public decentralized blockchain platform. In the document we will use “Ledger” or “Distributed Ledger” to refer to any DLT implementation.

The Ledger will provide required data protection and trust. It allows the data to be stored and managed by multiple equal parties (e.g., members of the supply chain, such as suppliers, manufacturers, distributors, etc.) without central authority. This approach eliminates the possibility of fraud by one/single authority. Any attempt to falsify data will be detected and rejected by the members of blockchain network, who independently validate and control the correct version of the data.

In preferred embodiments, a blockchain based system and method that uses the Ledger to store and validate unique product identifiers, notary data (hashes) of products information and events/updates (e.g. description, pictures, transportation and storage conditions, location, state, target market, etc.), confirm product authenticity, use the Ledger to register chain of ownership transfers (as the product goes through the supply chain), and use the Ledger and smart contracts to prove ownership of the product. These features allow a consumer to validate seller's ownership of a product unit or the authenticity of the goods. If a seller of the product unit cannot prove ownership of the unit using the Ledger, it indicates that the product unit is counterfeit. If a seller cannot prove, using the Ledger, that the product unit is allowed for sale in his location, it indicates illicit trading of the unit, such as grey market goods. These are simple requests, yet, current systems have no ability to determine such ownership, authenticity, or whether the goods are being sold in the proper channels. Accordingly, the systems and methods herein provide for a unique approach and novel treatment towards these issues.

The following detailed description is of the best currently contemplated modes of carrying out exemplary embodiments of the invention. The description is not to be taken in a limiting sense but is made merely for the purpose of illustrating the general principles of the present invention.

Broadly, an embodiment of the present invention provides a Ledger system, which may include API, Ledger, portals, and the like, for verifying authenticity of the products based on prove of ownership and transfer of ownership.

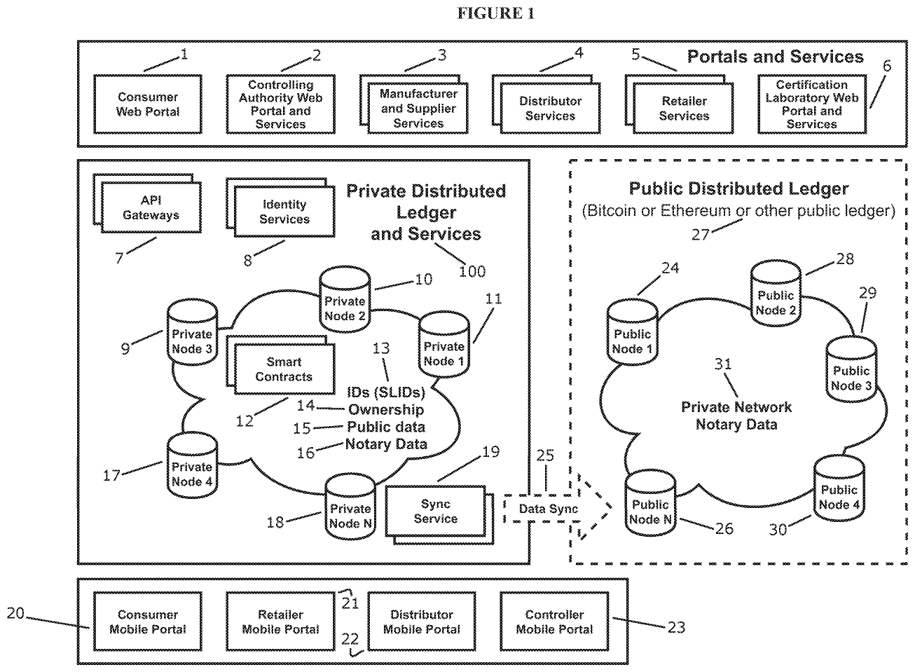

Referring now to FIG. 1, the present invention may include a method for preventing illicit trading, counterfeiting and decreasing the risk of corruption, wherein the method embodies a Ledger system.

The Ledger system may comprise a plurality of portals and services, which are accessible via a web browser. Each class will have a log-in and depending on the particular class and goods, there may be the same or different Graphical User Interface (GUI) to enable these users to access the web site and the services. For example, a consumer web portal 1, a controlling authority web portal and services 2, manufacturer and supplier service 3, distributor services 4, retailer services 5, and certification lab web portal and services 6, each are different variations of the services. The consumer web portal 1 therefore, is preferably accessible via a web browser and provides a page on the world wide web, or another access point where a consumer can engage with the system. For example, to request authentication, confirm goods, and to generate elements required from the system for verification. Similarly, the controlling authority 2, manufacturer and supplier 3, distributor 4, retailer 5, and certification lab 6, also have portals for entering data, for accessing data, for making requests, sending data, confirming data, and the like. These portals are entry points into the system that provide a location for creating of certain data that enables the system to create and send content.

Accordingly, to engage such portals, embodiments of the present invention may include at least one computer with a user interface. Each computer may include at least one processing unit and a form of memory including, but not limited to, a desktop, laptop, and smart device, such as, a tablet, smart phone, wearable device or implantable device. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

This system and method includes the following components and steps: setup of the Ledger without central authority 100; registration of supply chain members (manufacturer 3, distributor 4, retailer 5, authority 2, etc.); the registration of the product (typically by an originator, such as the manufacturer) to the Ledger along with detailed information about product; the originator requests or creates unique ID (SLID) 13 for the product unit and attaches it to the product unit. With regard to origination of a SLID, several options are available, but typically the originator can upload an SLID or the system can generate an SLID through the platform. Information about ownership is created and associated with said product unit in the Ledger with the creation of the SLID. Registration of the product is defined within a node (i.e. a database), with a plurality of nodes possible. Thus, the request to a register is submitted to one node, and that first node propagates the request to other nodes, each of which validates and stores the data, followed by consensus to synchronize data (the state) among the nodes. Each node has a complete copy of the data. As those of ordinary skill in the art recognize, an element of the distributed node system is that private nodes 1, 2, 3, 4, and N, (nos. 9, 10, 11, 17, and 18 in FIG. 1) allow for registration of any given datapoint across different nodes. This way, if one node is changed manually, the rest of the nodes will have accurate data and the change can be noticed, and thus the manually changed node would be flagged as improper. This gives credibility to the data, as changing data becomes impossible, unless you can make all changes across all databases, and confirm the accuracy of those changes.

Therefore, use of a Ledger system allows for storage of SLIDS 13, ownership data 14, public data 15, and notary data 16 among at least two non-centralized nodes. As a result, as the product unit is moved through the supply chain, ownership is tracked in Distributed Ledger 100, whereby on any trade (change of ownership) between the members of supply chain can be registered/stored (“Notarized”) on every node and this allows a seller to prove ownership of the product item to a buyer using Distributed Ledger 100. Ownership, being confirmed can then also be safely and securely transferred, so that at any moment, failure to prove or transfer ownership results in a complaint and investigation by authority. All members of the supply chain, including the consumer, can examine provenance and full history of the product unit (members of the supply chain can choose, which details to disclose). This provides a powerful and clear chain of title to allow all within the supply chain to be confident that they are trading in genuine goods and ultimately, this gives consumers confidence in said goods.

When communicating between the portals and services to a Ledger, there must be an API gateway 7, to allow for such communication to occur. Furthermore, the identity services 8 manage an identity for each entity or person that enters the private ledger system 100. The identity services 8 stores or validates data about a company, company managers or individual. This identity can be utilized to confirm and register a company, in certain applications of the embodiments. Thus, to confirm identity, the identity services 8 can be utilized to confirm the data about the company, when such information is necessary to validate and prove ownership.

As a product itself is registered within a given node in the Ledger, access to this node is provided through the API gateway 7, and then either through a web portal, i.e. the consumer web portal 1, or a mobile application, e.g. the consumer mobile portal 20. The system is engaged when any actor asks for verification of a good and scans a SLID 13 to begin the process to validate authenticity. When a sale or trade occurs between a retailer and consumer the product unit is scanned appropriately to confirm and verify the transaction. If the product unit is marked as counterfeit, all registered consumers, who scanned or acquired product units with equal SLID (or optionally product units from the same batch), may receive an alert. SLID 13 can be represented in different forms such as QR code, RFID tag, NFC tag, and others.

FIG. 1, therefore further details that there are certain API gateways 7 necessary to allow for communication between the various portals and the database systems of the Ledger 100. When in use, a smart contract 12 within the system tracks and controls ownership of data within the nodes, and these track the individual ID's within the system. Smart contract 12 is a self-executed computer code (a set of instructions) that is deployed to the Ledger 100. Therefore, the IDs (SLID's) 13 and ownership 14, and public data 15, and notary data 16 are all forms of data that may be stored within a node and tracked and managed by smart contracts 12.

Nodes, within the system such as private node 1 (11), are databases that allow for storage of certain data. An individual database can be easily manipulated, but when used with other nodes, i.e. private node 2 (10), private node 3 (9), private node 4 (17), and private node N (18), these nodes replicate data entries, and confirm that the data from one node matches data in other nodes, thus making manipulation impossible. This prevents manipulation of a single data entry, because the other nodes would not be in agreement with another, and thus data could not be verified by consensus.

Indeed, a plurality of private nodes increases strength of the data. However, data can be further strengthened by inclusion of large public Ledgers i.e. those in use by Bitcoin or Ethereum, or the like. Thus, we can optionally include, in certain embodiments, communication between private ledgers 100 and public ledgers 27. The private ledger 100 can connect to public distributed ledger 27 via sync service 19 that allows for data to sync 25 between the private 100 and public ledger 27. Thus, any individual data points on the private ledger 100 may also exists on a public ledger 27, which provides a further layer to verify the data. For example, by submitting data points of a private ledger on a regular basis, whether this is every transaction, or hash of all daily or weekly transactions (private network notary data 31) or some other defined or variable, the snapshots of the database can be confirmed in the public ledger 27, such as in public node 1 (24), public node 2 (28), public node 3 (29), public node 4 (30), and public node N (26). In preferred embodiments, a hash of all daily transactions is confirmed in a public ledger 27, however, in other preferred embodiments, a hash of all transactions is confirmed every hour in a public ledger 27.

Each of the consumer, retailer, distributor, and controller, may use a mobile, wearable, implantable application or equivalent access to access the platform. The consumer mobile app 20, for example, can have a simple GUI to allow the consumer to scan a SLID 13, request confirmation, receive information back form the network, confirm the same with the retailer, and to perform other actions or receive data as necessary under the various embodiments. A consumer is not the sole user of the mobile platform, and a retailer may contain a retailer mobile app 21, which may also allow the retailer to scan an SLID 13, to connect to the ledger system 100, to confirm and transfer ownership 14 of a good; and wherein the ownership can be confirmed on one or more of the nodes private nodes (9, 10, 11, 17, 18). Additional mobile apps, such as the distributor 22, and controller 23, are additional accesses into the private ledger 100, instead of through the web applications of features 1-6.

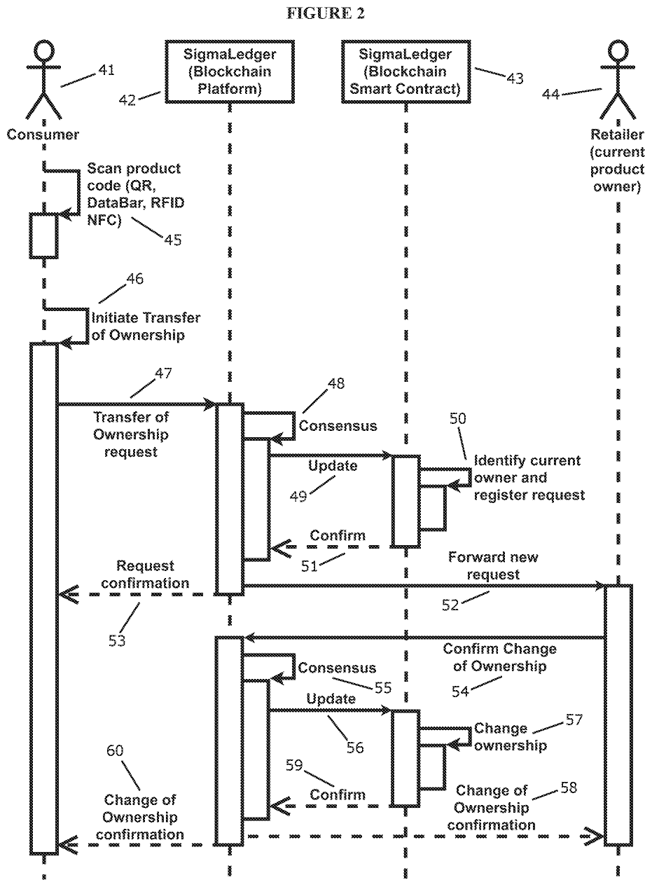

FIG. 2 details several steps that describe a transfer of ownership process, which may be essential for the method for eliminating certain types of counterfeiting techniques. For example, the inability of the seller (current owner of the product) to transfer ownership to a buyer may signal that the seller is not authorized to sell an item or item does not belong to a seller and the items being sold is counterfeit. FIG. 2 begins with a consumer 41, and the consumer 41 is interested in a particular product. The consumer 41 is registered within the system and has an ID so that, where a consumer 41 seeks to become an owner of a Product Unit, an ID is already confirmed within the system. Accordingly, when any user to the system joins, that person or company is given an ID to be able to be tracked and to own, sell, and otherwise dispose of goods within the system. The consumer 41 can use a consumer mobile app (20 in FIG. 1), and scan a product code 45, that is physically on a product. The product code is a physical product code, such as a Bar code, QR code, DataBar, RFID, NFC, DNA, chemical code or signal, or other known or developed physical code. The consumer 41 wishes to buy a product, and so the purchase itself means that an actual transfer of the title needs to occur. Accordingly, this would result in a transfer of the ownership from the retailer 44 (current owner) to the consumer 41.

To begin this process, the consumer 41 scans the code 45 and this begins or initiates the transfer of ownership 46, for example, by the consumer choosing to “transfer ownership” or “buy” the product on a mobile app 20 (in FIG. 1). This sends a transfer of ownership request 47 to the public address of the smart contract 43, for example through an API 7 (in FIG. 1). The transfer of ownership request 47 then hits the Ledger system 42, wherein the transaction request is registered and propagated to the Ledger 100 (in FIG. 1) nodes. Transaction processing triggers (update 49) the execution of smart contract 43. The final state (new data updates, new transactions, result of smart contact execution, new state of smart contract, etc.) is validated and synchronized with consensus protocol 48. Consensus protocol is used to validate and synchronize the data (the state) between the nodes, it makes sure all nodes are in sync. The Ledger 100 (in FIG. 1) may utilize different kinds of consensus protocols e.g. Proof of Work, Proof of Stake, Delegated Proof of Stake, Proof of Elapsed Time, etc., and others as known to those of ordinary skill in the art. A consensus simply means that all nodes compare data and each agrees with the data regarding that transaction. This may be occurring in parallel, i.e. all nodes are confirming together at once, or sequentially, or a combination of parallel and sequential.

Smart contract 43 as used herein means a self-executed computer code (a set of instructions) that is deployed to the Ledger 100 (in FIG. 1). Once the smart contract is deployed to the Ledger, the smart contract gets a public address assigned. Every node will have a copy of the smart contract. To trigger the execution of the smart contract a transaction needs to be sent to the public address of the contract. Thus, the transfer of ownership request is sent from the consumer 41 (using consumer mobile app (20 in FIG. 1)) via API 7 (in FIG. 1) to one of the nodes to the address of the smart contract 43. The node registers a transaction with the request in the processing queue and propagates it to other nodes in the Ledger. The transaction is processed by every node independently. Transaction processing triggers (update 49) the execution of smart contract 43. The smart contract 43 identifies the current owner of the product and registers the transfer request 50 having the buyer (consumer) address and the current owner address. The final state is validated and synchronized with consensus protocol 48 and may be confirmed with a notification 51 (an example of notification can be a validated data block in the Ledger).

Being acknowledged by smart contract 43, the request is sent to the current owner 52 and then there is a receipt (acknowledgement of the request) returned back to the consumer 41 of the request for the confirmation 53. The current owner then receives an alert to transfer the ownership and the confirmation request is confirmed 54. For example, within one of the various mobile portals or web portals, a GUI provides a notification, the notification can be elected and this confirms the receipt of and transfer of ownership from the retailer (owner) side. Thus, a box can be selected, a button pressed, etc. that confirms the particular action to be taken, and by confirming that action, the transfer request proceeds.

The confirmation of ownership 54 then sends a transaction back via API and node to the smart contract 43. The transaction is processed by the nodes by triggering (update 56) the execution of the smart contract 43. The smart contract 43 matches the new confirmation with the original transfer request from the consumer 41, and validates the signature of the current owner's ownership rights and changes ownership 57 to consumer 41. The final state is validated and synchronized with consensus protocol 55 and may be confirmed with notification 59 (an example of notification can be a validated data block in the Ledger). Being acknowledged by smart contract 43, the confirmation is sent to the previous owner 58 and then there is a receipt (acknowledgement of the transfer) 60 returned back to the consumer 41, which is now the owner of the Product Unit or goods. All such records would now be updated within the Ledger platform 42 as well as in the smart contract 43 of the new ownership status.

Accordingly, the system allows a process where a consumer initiates the transfer of ownership by signifying the interest in buying a good. Once the product in scanned 45, this allows a series of steps that confirms the status of the product with the current owner, confirms the request back to the Ledger systems, and provides information that allows for confirmation that the product code 45 actually confirms with and identifies the good being scanned. Should there be any information that is out of line, then the consumer 41 will know that the product is suspect, or plainly counterfeit. For example, if the product code 45 identifies a different name than the retailer 44, that would suggest that the product is already sold, and that the scanned code was fraudulent. Or, if the product code 45 shows a different product than what was scanned by the consumer 41. For example, if the consumer 41 scans a luxury handbag, but the product code 45 shows that the code is related to sunglasses, the result shows a clear confirmation that the product code 45 and the product scanned is not valid and that the product is questionably authentic. These actions can take place in real-time, wherein the scanning of a product code begins the sales process, and the steps are taken to transfer ownership from one owner to the next. For example, these actions can also take place by pallet or bulk, wherein a manufacturer (the first owner), sells products to a wholesaler (who becomes the second owner), and then to a retailer (the third owner), before a customer (4^{th} owner) buys the product unit. Each transfer may be visible to the subsequent owner, which allows one to confirm chain of title of the goods.

To properly validate a request, it is necessary to utilize smart contracts to process, validate and store the data and consensus protocol to synchronize the state/data between nodes. Where a datapoint is improper, it indicates that the request or the product is faulty and thus indicates a risk of fraud.

In simple terms, the transfer of ownership request 47 requires a transaction request that will trigger the execution of the smart contract to identify the current owner 50 of the product and continue the process to modify the ownership to the consumer, who will be the new owner. The result of the smart contract execution, data updates (the state) will be confirmed and synchronized between N number of nodes with the help of consensus protocol 48.

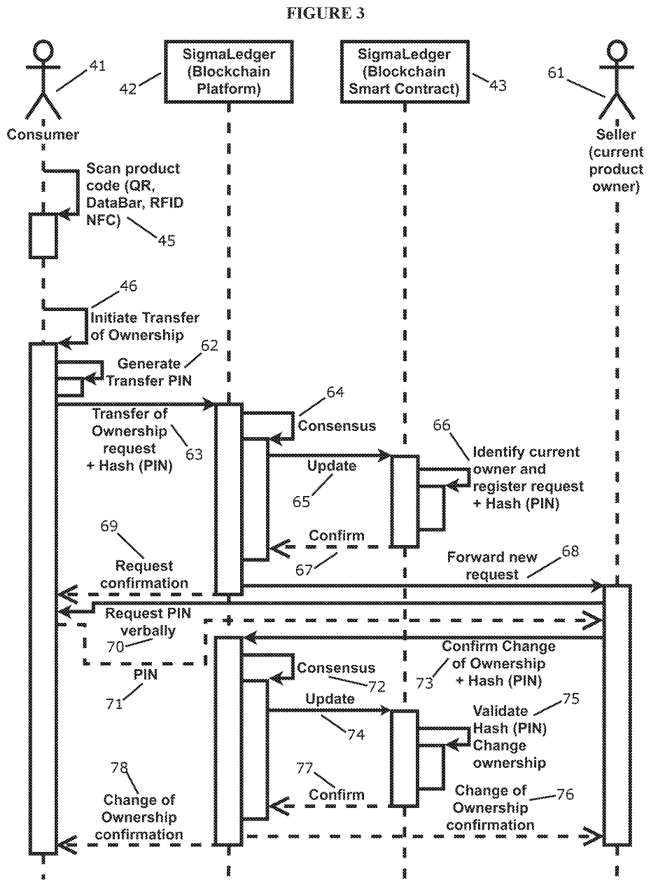

FIG. 3 details some of these elements in an example of an ownership transfer between a consumer 41 and a seller 61 that further incorporates the generation of a Personal Identification Number (PIN) to provide a further clear layer of validity. As an example, the process with a PIN may protect from the situations when the seller receives multiple ownership requests, having some of the requests being fraudulent request. The seller is running with the risk of accepting a wrong (fraud) request, therefore a PIN will protect consumer and seller from making a mistake. FIG. 3, begins just like FIG. 2, where the consumer 41 begins by scanning a product code 45, for example, by using a consumer mobile app 20 (in FIG. 1). In this way, the consumer 41 is in control of the app and is control of what code is actually scanned, and thus this reduces the risk of a slight of hand approach towards someone else scanning another code, i.e. a fraudulent code. Once this code is scanned there begins the process to initiate transfer of ownership 46. This generates a transfer PIN 62, that is known to the consumer 41, and is unique so that in a subsequent step, the action of confirming the PIN is necessary to enact the transfer, and that it would otherwise be nearly impossible to guess or fabricate the PIN to fraudulently make the transfer.

Thus, after the transfer PIN 62 is generated, a transfer of ownership request with hash (PIN) 63 is submitted. This follows as above with FIG. 2 except for the addition of the transfer PIN 62. Indeed, as with FIG. 2, there must be a transaction request 63 to trigger the execution (an update 65) of the smart contract 43. The identity of the owner and the request with hash (PIN) registration in smart contract 66 follows, and if accurate, consensus 64 will validate and synchronize the state between nodes resulting in confirmation 67 occurs. Then a new request 68 is generated to the seller 61, with a confirmation (receipt) that the request was sent 69 is shared with the consumer 41. The PIN can be requested 70 by seller 61, and to ensure further validation that the transfer request and product is valid, consumer provides correct PIN 71. Thus, either the buyer or seller may utilize the PIN to confirm the correct transaction. If a seller has two requests, the use of a PIN will allow the seller to validate the correct request and approve only the correct request.

The PIN 71 being provided, the confirmation of ownership including hash of the PIN (PIN 71) transaction 73 send back via API and node to the smart contract 43. The transaction processing triggers the execution (update 74) of the smart contract 43. The smart contract matches the new confirmation+hash (PIN) with the original transfer request from the consumer 41, and validates the signature of the current owner. Thus, the smart contract confirms Ownership rights and changes ownership 75 to consumer 41. The changes are validated and synchronized by consensus 72 with confirmation 77. Being acknowledged by smart contract and validated by consensus, the confirmation is sent to the previous owner 76 and finally a change of ownership confirmation 78 is shared with the consumer 41. Absent the PIN, the transaction cannot proceed, as the PIN acts as a gate to execution of any changes. Thus, the addition of the PIN ensures a second level of protection against a fraudulent modification of any one node or of any complete transaction across all nodes.

Thus, FIGS. 2 and 3 differ primarily through the additional use of a PIN in FIG. 3 in addition to the safety protocols of FIG. 2. In some ways, this is valuable as it creates two layers of confirmation, one being computational, through consensus between nodes within a database, and secondly, through a simpler exchange of verbal or written PIN, that verifies that what is being completed is really for the same request from the consumer. In some ways, such PIN, because of the simplicity of what occurs, takes away the “black box” feel of the Ledger system, as consumers are well versed on the use of such PIN or passwords for access.

These steps describe methods of validation by the consumer of the authenticity of the product unit as well as post factum alerting mechanism. At any step, failure to prove or transfer ownership, or mark SLID as sold, or attempt to sell SLID in a region not designated for a specific lot/batch, or any other discrepancy between product unit description and the actual product unit, indicates illicit trading and/or counterfeit. Thus, considering a batch of products, scanning of certain SLID's can verify the authenticity or fraudulent nature of the products. After investigation of several units, if the goods are found to be fraudulent, the whole lot/batch can be marked as counterfeit and all registered owners will be alerted through a post factum alerting mechanism. For example, each registered owner may receive a text, email, or call alert regarding the potential for fraud, and thus allow them to take remedial action to prevent the propagation of the fraud.

In other words, every product unit may be assigned a unique ID (SLID) 13. Ownership of the product unit is tracked by the Ledger. For every trade, ownership of the ID 13 can be proven by Seller. Failure to prove ownership or location mismatch, or product unit property mismatch, indicates illicit trading or counterfeit.

There are numerous counterfeit scenarios that can be prevented using the method described in the embodiments herein, several of which are outlined below. However, these examples do not in any way limit the scope of the embodiments towards other uses:

Arbitrary SLID is Generated and Attached to Product Unit

A dishonest seller can attempt to generate fake SLIDs for counterfeit items and try to sell them as genuine to a client or consumer. In this case, consumer, who is about to purchase the item can verify the status of SLID in the Ledger. SLID will be reported as invalid/unknown by the Ledger, hence counterfeit can be detected and reported.

Genuine SLID is Replicated and Attached to Multiple Product Units

Dishonest owners can try to copy SLIDs from the genuine items and apply copied SLIDs to counterfeit items. In this case, as soon as one item is sold, SLID will be marked as “sold” in Distributed Ledger. This will make it impossible to sell a fake item with the copy of the SLID. Distributed Ledger will block second attempt to sell already sold SLID and notify Consumers and other parties about possible counterfeit.

Selling Product Unit Produced for a Certain Region in a Different Region

A consumer can detect that regions for valid sale or trade do not match because the region of the product unit is stored in the Distributed Ledger and available for verification. This check can be performed automatically based on the current location of a user. Such “grey market” goods may cause problems because of incorrect languages for safety issues, or where variations of products are intended for commercial or other purposes. Therefore, grey market products, even if genuine in the intended country of sale, remain counterfeit in the non-intended country of sale.

SLID Stolen from Authentic Unit

The SLID is stolen from the authentic unit (for example, photographed in the store) and then attached (physically, digitally, or in any other way) to a counterfeit product unit. The product unit will pass verification as authentic (assuming the real owner has not yet sold the original authentic item; otherwise unit will be reported as counterfeit). However, seller will not be able to prove ownership of the SLID, mark SLID as sold, transfer ownership or perform any other operation on SLID because he is not a registered owner of this SLID in the Distributed Ledger. Failure to perform one of the mentioned above operations will indicate counterfeit.

An individual or team of individuals can make the system disclosed above through the following process: use one of the existing public ledger (Ethereum, Bitcoin, Hyperledger, R3 Corda, etc.) to create public or private or hybrid (combination of public and private) Ledger (e.g. blockchain distributed ledger); or create own public or private or hybrid blockchain like distributed ledger; allow any interested party as well as individuals to join the distributed ledger, operate one or more nodes and act as additional validator and controlling member; create components, services and APIs for such parties to minimize the effort to join the ledger; create workplaces for members of supply chain (supplier, manufacturer, distributor, retailer, etc.); create Digital Identity systems, which will be used for authentication and allow anonymous access for certain scenarios; create SLID generator, which creates global unique identifiers for product units and batches; create ownership tracking logic (for example, using workflow engines or state machine or smart contracts or other); there can be one of more smart contracts created and deployed to the distributed ledger, each smart contact will have public address assigned; deploy the tracking logic to the distributed ledger; create API interface (for example, REST Web Services) for registering products, product units, querying information about products and product units, registering trades (transferring of ownership), proving ownership, change status of the product unit, and other operations; create retailer mobile application for product unit validations, transfer of ownership and changing product unit status when product unit is sold to consumer; and create consumer mobile application for product unit authenticity validation, proof and transfer of ownership and submitting complaints, the consumer mobile application should allow but should not require registration. Validation of product unit can be done by scanning QR code (or other physical form of SLID). Validation of product unit shall not require proprietary consumer application and can be done using customary QR code scanner (or any other depending on the way of SLID representation).

Ownership tracking through the distributed ledger components are necessary for the above-disclosed method to work. The ability to include other parties or individuals to the ledger is optional, though improves trust. Solutions embodied by the present invention can work on a private ledger. Identity management component is required but can be provided by the 3rd party as software as a service. Ownership can be tracked in different types of storage, not only blockchain, but in any number of Ledger systems that allow for distributed nodes to verify data. Product Unit ID (SLID) can be presented in different forms and formats such as QR code, RFID tag, NFC tag, serial number, bar code, DNA, chemical tag, and others. Special scanning devices can be used for scanning and validation instead of generic mobile phone scanners. Indeed, the SLID may also include chemical ID, and other IDs that are not visible to the naked eye.

A method of using the present invention may include the following. Members of supply chain must register their products in the Distributed Ledger, generating or uploading unique IDs (SLIDs) and attach them to individual product units. Ownership of the SLID can be validated at any trade, whereby the ownership must be transferred at any trade. SLID must be marked as “sold” when product unit is sold to a consumer. A consumer can demand proof of ownership and mark as sold utilizing procedures from the retailer. Failure to prove or transfer ownership as well as attempt to sell “sold” SLID, indicates counterfeit. Furthermore, via the processes described herein, the consumer exists as an owner of the good, and confirmation of that transfer of ownership is provided in real-time to effectuate said transfer within the Ledger. Accordingly, the consumer must also have an ID within the system so that the consumer can be tied to the product unit once the consumer becomes the owner.

Additionally, ownership tracking and validation can be integrated with electronic stores and/or POS terminals so that all operations happen during the purchase automatically, whereby a proof of ownership mechanism can be used to prove an ownership of stolen item. Product information stored in ledger can be used for additional validations such as location, where the product unit is being sold, product look and feel, and other indicators of identification. SLID tracking mechanism can collect and track the data (e.g. location, temperature, humidity, pressure, etc.) from sensors. It can be used for supply chain tracking and control such as logistics, transportation conditions, food temperature changes, and other. Ledger system can be used as product database to provide consumers with product specific information such as manuals, specifications, news and alerts, and other. Consumers can submit feedback and reviews, while the system can confirm that the feedback and reviews are coming from a legitimate owner. The present embodiments can also create a warranty service that can be built on top of the system, a loyalty distribution service that can be built on top of the system, and/or an insurance service that can be built on top of the system.

The computer-based data processing system and method described above is for purposes of example only and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are contemplated as within the scope of the present invention.

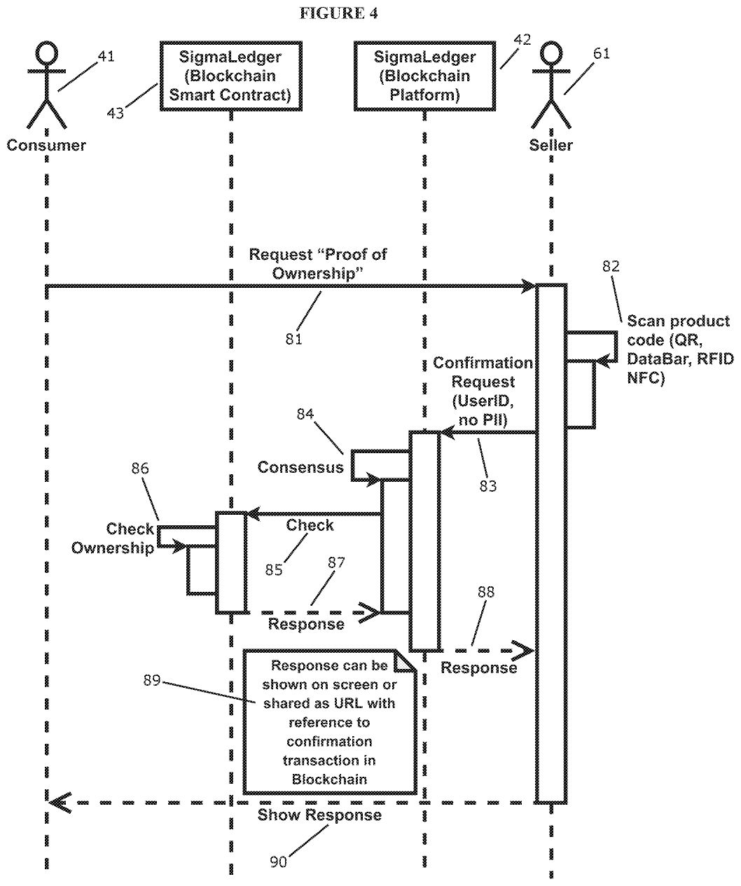

Accordingly, an example of the above embodiments is detailed in FIG. 4. A consumer 41, seeking to buy a good, verbally requests “proof of ownership” 81 of said good from the seller 61, who scans the product code 82, and sends a confirmation request 83 (transaction) to a smart contract 43, transaction processing triggers the execution (check 85) of the smart contract 43. The smart contract validates the signature of the seller 61 and validates ownership rights, smart contract may send a new transaction to the seller 61 confirming the ownership. Consensus 84 will synchronize the result the execution (the state) amongst nodes with confirmation 87. The seller 61 receives the notification response 88 with result of the request. The response can be shown on a screen, shared as a URL, or other reference to show that the reference information is actually confirmed within the Ledger 89, and then the seller 61 can actually show the response 90 to the consumer 41. Other embodiments may include providing a written receipt, for example where a consumer 41 provides an email or phone number, so as to receive detail of the confirmation within the Ledger 89.

This again provides for a quick and efficient manner to verify the accurate and valid ownership of a good and allows a consumer 41 to verify the same with the purported seller 61. Through use of such embodiments, sales and offers to sell fraudulent goods should be dramatically reduced, as a consumer 41 will be unlikely to buy goods that do not have the proper paperwork or provenance to be genuine articles, and to be properly residing with the actual owner/seller 61.

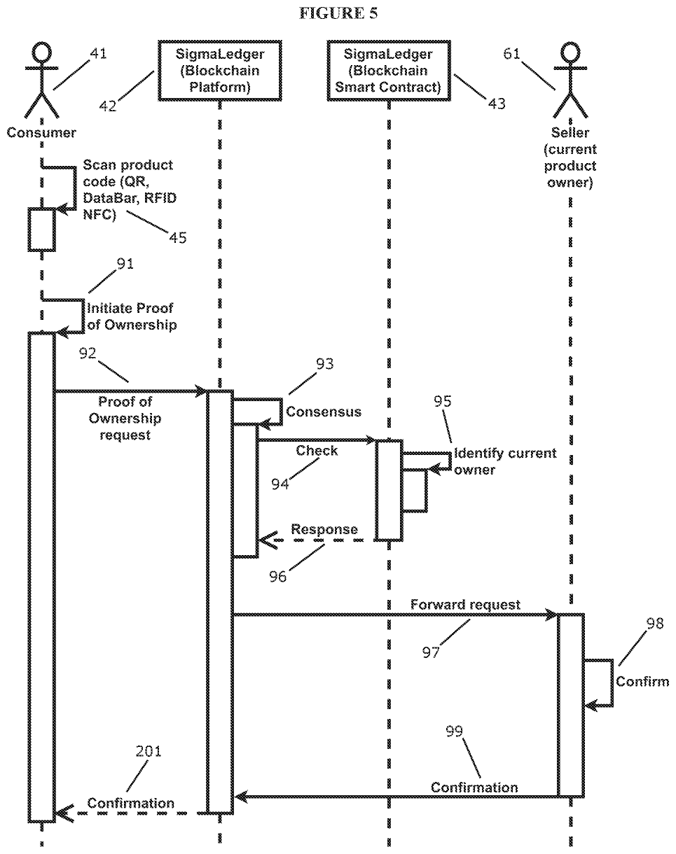

FIG. 5 is differentiated from FIG. 4 above, as the embodiment of FIG. 4 details the consumer requesting verbally proof of ownership, while FIG. 5 details where a customer scans the product and initiates the proof of ownership over a mobile or web-based portal. Thus, FIG. 5 shows a further embodiment of how the consumer 41 can confirm ownership, by again scanning a product code 45, and initiating proof of ownership request 91, which sends the proof of ownership request 92 to the blockchain platform 42 and smart contract 43, the request processing triggers the execution of the smart contract 43. The smart contract 43 identifies the current owner 95. Consensus synchronize the state with confirmation 96. A request is forwarded 97 to the seller/owner 61 who confirms 98 the ownership, and then sends a confirmation back to the blockchain platform 42 and finally a confirmation 201 to the consumer 41. The seller/owner may send/register a confirmation transaction 99 addressing the consumer 41 or smart contract 43 in the Ledger.

It should be understood, of course, that the foregoing relates to exemplary embodiments of the invention and that modifications may be made without departing from the spirit and scope of the present invention.

What is claimed is:

1. A system for determining and verifying authenticity of a product unit comprising: a ledger system comprising at least two nodes; at least one product code attached to said product unit, said product code having an entry in said at least two nodes, said entry defining at least a current owner and a hash of product information; said system capable of self-executing computer code for providing a request for transfer of ownership of said product unit by initiating a request from a portal or API, and accessing a first node of the at least two nodes; sending the request from the first node to a second node; engaging a self-executed computer code via confirming said ownership between said first and second nodes; and forwarding a request to an owner; upon approval by the owner confirming a change and engaging a self-executed computer code via confirming the validity of the change of ownership request and approval followed by consensus, making the change of ownership of said product unit within said first and second nodes.

2. The system of claim 1, wherein an API is utilized to access between the portal and the ledger system.

3. The system of claim 1, further comprising sending a receipt of said request from the portal to a buyer.

4. The system of claim 1, further comprising sending a change of ownership confirmation to a requester (the new owner) and previous owner.

5. The system of claim 1, wherein upon approval by the owner, a consensus is defined between said first and at least second node of the approval of the change of ownership, and upon consensus, making the change within said first and second nodes.

6. The system of claim 1, wherein the first and second nodes are operated by independent parties who participate in parallel, and wherein a change to any node is only propogated upon consensus between the first and second nodes.

7. The system of claim 6, wherein consensus defines that no change is made to a node without the consent from all other parties.

8. The system of claim 1, wherein there are three or more nodes.

9. The method of claim 1, wherein each node has a complete copy of all transactions.

10. The method of claim 1, wherein data is partitioned among a plurality of nodes, wherein within each partition, each of the plurality of nodes has a complete copy of all transactions.

11. The system of claim 1, wherein the data points from the nodes are synced to a public ledger.

12. The system of claim 9, wherein a hash of transactions from said nodes is synced with the public ledger.

13. A method of transferring ownership of a Product Unit within a ledger system comprising:
a. generating an ID for a Product Unit; registering said ID within a node within said ledger system and attaching said ID to the Product Unit; propagating the ID within at least a second node within said ledger system;
b. scanning the ID and submitting a request (transaction) to the Ledger;
c. processing the request (transaction) and upon receipt of said request (transaction), executing a series of code to identify the current owner and registering the request in the ledger system; wherein the execution defines a change in at least one transaction data; and wherein said transaction data is validated and synced between the first node and at least second node in the Ledger;
d. receiving a notification of the request by the current owner, and defining a transfer approval wherein said current owner approving the request to transfer to a requester;
e. wherein the transfer approval (transaction) triggers execution of a self-executing code to match the transfer approval with the request, validate the approval and confirm the change in ownership by registering transaction data on the first and at least second nodes within the ledger; and
f. generating a notification confirming the change in ownership.

14. The method of claim 11, wherein the process of the current owner approving the request to transfer ownership to a requester, wherein the approving is performed by the current owner singing the request; and wherein the validation is of the signature.

15. The method of claim 11, wherein the request is generated by a requester.

16. The method of claim 11, wherein registering said ID within a node defines an owner and information regarding said owner.

17. The method of claim 11, wherein the step of submitting a request generates a PIN.

18. The method of claim 15, wherein the PIN must be confirmed before change of ownership within the first and second node in the ledger

19. A method of proving ownership of a product unit comprising:
a. generating an ID for a product unit and registering said ID within a ledger system among a plurality of nodes to define an owner of said product unit; and attaching said ID to the product unit;
b. scanning the ID on said product unit and submitting a request to confirm the ownership on the ledger;
c. submitting said request wherein receipt of said request triggers execution of self-executing code to identify the current owner;
d. validating a data point, said data point defining at least the current owner among the plurality of nodes within the ledger and forming a consensus of said data point from said plurality of nodes;
e. generating a notification on the request to the owner; and approving the notification;
f. validating the approved notification among the plurality of nodes; and upon consensus among the plurality of nodes, confirming the ownership of said product unit; and
g. generating a notification of the ownership.

20. The method of claim 19, wherein the request to confirm ownership and the resulting confirmation are registered among the first and at least second node and may be used as a reference accessible via the API.

21. The method of claim 19, wherein registration of the product is defined within a node (i.e. a database), with a plurality of nodes possible.

22. The method of claim 19, wherein the proof of ownership request is submitted to one node, and wherein that first node propagates the request to other nodes, each of which validates and stores the data, followed by consensus to validate and accept (store) the data among the nodes.

23. The method of claim 19, wherein the proof of ownership approval notification is submitted to one node, and wherein that first node propagates the request to other nodes, each of which validates and stores the data, followed by consensus to validate and accept (store) the data among the nodes.

24. The method of claim 19, wherein each node has a complete copy of the data.

25. The method of claim 19, wherein data is partitioned among the plurality of nodes, wherein within each partition each node has a complete copy of the data.

26. The method of claim 19, wherein in step (c) the self-executing code is executed via submitting a request to a public address in the ledger.
